(19) United States
(12) Patent Application Publication
(10) Pub. No.: US 2002/0049514 A1
(43) Pub. Date: Apr. 25, 2002

(54) Method for compensating for static position errors and orientation errors

(75) Inventor: Thomas Puchtler, Adelsdorf (DE)

Correspondence Address: BAKER BOTTS L.L.P., 44TH FLOOR, 30 ROCKEFELLER PLAZA, NEW YORK, NY, 10112-4498, US

(73) Assignee: Siemens Aktiengesellschaft

(21) Appl. No.: 09/848,684

(22) Filed: May 3, 2001

(30) Foreign Application Priority Data
Sep. 18, 2000 (DE) 100 460 92.5

(51) Int. Cl. G06F 7/00

(52) U.S. Cl. 700/245

(57) ABSTRACT

Method for compensating for static position errors and orientation errors At a number of different workpoints (P0 . . . Px) in the workspace A of a processing machine, any positioning and orientation error which may exist is first measured. The nominal positions (X_soll and O_soll) are entered, together the associated position errors (rA, oA) in a compensation table (K). These compensation values are included in the calculation for generating the guide values from position inputs. As a result, firstly the position error disappears at the measuring points. In the intermediate spaces, the values are interpolated from the compensation table (K) as a result of which the deviations are reduced there, too.

### FIELD OF THE INVENTION

The invention relates to a method for compensating for static position errors and orientation errors in guiding the movement of a moving machine element of an industrial processing machine such as a numerically controlled machine tool, a robot or the like, with a setpoint input for generating reference values for one or more drives for controlling the machine element in a predetermined workspace.

An important consideration in the design of industrial processing machines is, among other things, maximum precision in the positioning of machine elements in order to meet the present-day requirements for the accuracy of, for example, workpieces to be produced by a numerically controlled machine tool.

The absolute positioning and orientation accuracy of machine tools and robots is impaired by, among other things, the following factors:

by leadscrew errors in the case of linear shafts with ball-and-screw spindle drives.

due to a sag in the guide rails, e.g. due to the weight of the tool and the spindle of a machine tool.

by twisting and lack of straightness of guide rails.

by angularity errors between the guide rails.

due to inadequate information on actual geometric dimensions of components.

The drawing dimension is then frequently used instead of the correct information.

in the case of non-Cartesian machine tools and robots, the coordinate transformation of the control is frequently only placed on a simplified mathematical model in order to limit the computing time and to keep an overview of the number of geometric parameters.

After a processing machine has been taken into operation, the positioning accuracy and in rare cases also the orientation accuracy in the workspace is often measured with the aid of external measuring means. Depending on the application, these are frequently not sufficient for the above reasons.

There are established methods for compensating for the causes of leadscrew error and sag. The twisting and angularity error are countered by engineering means by inputting more narrow tolerances. However, this increases the expenditure exponentially with the required accuracy and associated with this, also the costs for the corresponding processing machine.

The two error sources listed last, in contrast, are accepted as a rule or attempts are made to counter them by refining the mathematical model which, however, increases the software implementation and computing expenditure.

It is, therefore, the object of the present invention to create a method of the type initially mentioned by means of which, among other things, the above causes for positioning and orientation inaccuracies and, in particular, the two error sources listed last are compensated for.

According to the present invention, this object is achieved for existing static positioning inaccuracies by a method for compensating for these when guiding the movement of a moving machine element of an industrial processing machine such as a numerically controlled machine tool, a robot or the like. In this arrangement, a setpoint input is used for generating guide values for one or more drives for controlling the machine element in a predetermined workspace. The method exhibits the following method steps:

inputting nominal positions for the machine element for a predetermined number of different workpoints in the workspace,

determining positioning errors by comparing a respective nominal position and actual position of the machine elements for each of these workpoints,

storing the respective nominal position and positioning error found in a compensation table,

taking into consideration the positioning errors of the compensation tables as compensation values by

adding them in the generation of guide values for the drive or drives from the setpoint input in the respective nominal positions or by

interpolating the compensation values from the compensation table in the intervals between the respective nominal positions.

For existing static orientation inaccuracies, the above object is achieved by a method for compensating for these when guiding the movement of a moving machine element of an industrial processing machine such as a numerically controlled machine tool, a robot or the like. In this context, a setpoint input is again used for generating guide values for one or more drives for controlling the machine element in a predetermined workspace. The method exhibits the following method steps:

inputting nominal orientations for the machine element for a predetermined number of different workpoints in the workspace,

determining orientation errors by comparing a respective nominal orientation and actual orientation of the machine elements for each of these workpoints,

storing the respective nominal orientation and orientation error found in a compensation table,

taking into consideration the orientation errors of the compensation tables as compensation values by

adding them in the generation of guide values for the drive or drives from the setpoint input in the respective nominal orientations or by

interpolating the compensation values from the compensation table in the intervals between the respective nominal orientations.

To achieve the object of the invention both for static positioning and for orientation inaccuracies, a method for compensating is proposed in which the nominal positions are stored in the compensation table with associated position errors which contain the respective nominal positions and nominal orientations and the position errors and orientation errors.

According to an advantageous embodiment of the method according to the present invention, it has been found to be advantageous if the workspace of the processing machine has a cube-shaped form and is divided into a three-dimensional grid structure for determining workpoints. In this arrangement, the deviation between the nominal position and the measured actual position is stored for each grid point or a selection of grid points in a data field of the compensation table.

It is also advantageous for the conversion if the compensation table is embodied as a data array.

In addition, it has been found to be advantageous if the traversing area of the machine element is subdivided equidistantly for each degree of freedom of the processing machine. Each dimension of the workspace can then be described simply by the minimum value, the maximum value and the number of equidistant intervals.

The method can be performed in a particularly simple and effective manner automatically when the processing machine is taken into operation in that the desired positions in the workspace are approached via a corresponding parts program with traversing instructions for the setpoint input and, after the respective position has been reached, the actual positions are measured and transferred into the machine control system. The deviations are then determined there in the form of position errors and orientation errors, e.g. with the aid of the microprocessor integrated into a numeric control system and entered into the compensation table together with the associated positions.

The method steps according to the invention described above result in the following advantages, among others:

an increase in the static positioning and orientation accuracies.

a reduced requirement for the production tolerance of the components which provides for cost savings in the production.

the omission of special measuring devices for determining the geometric parameters needed for the mathematical model relating to a numeric control.

a possible simplification of the mathematical model which provides for runtime reduction in the control system.

the method according to the invention can be applied universally to any processing machines such as, for example, machine tools and robots.

Other advantages and details of the invention are obtained by referring to the exemplary embodiment shown in the text which follows and in conjunction with the figures in which elements having the same functions are identified by the same reference symbols and in which:

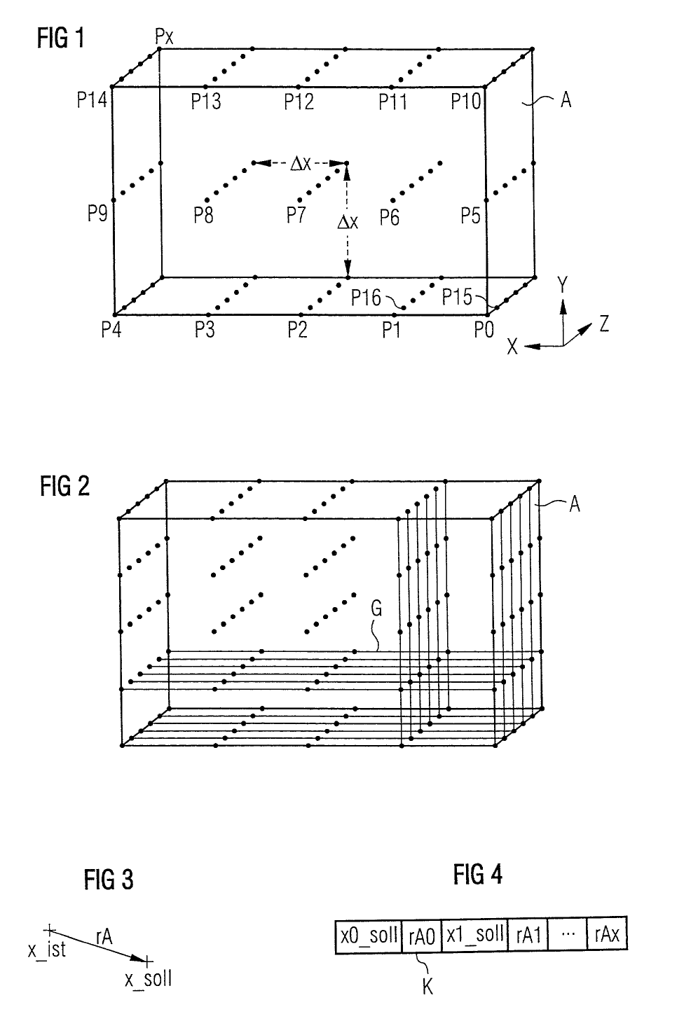

FIG. 1 shows a cube-shaped workspace with equidistantly subdivided traversing area,

FIG. 2 shows a cube-shaped workspace for a machine element with three-dimensional grid structure,

FIG. 3 shows the definition of the spatial deviation and

FIG. 4 shows an example of a compensation table for position errors.

The following statements initially refer to a workspace A as is shown, for example, in the representations of FIG. 1 and FIG. 2. At a number of different workpoints P0 . . . Px in the workspace A of a processing machine, an existing positioning error and possibly also orientation error is first measured. In the text which follows, the term “position” in this document comprises the position and the orientation.

The nominal positions X_soll and O_soll are entered, together with the associated position errors rA, oA, in a compensation table K. Such a compensation table K is shown in the representation of FIG. 4 as an example for position errors, in that the nominal position value X_soll followed by the associated compensation error rA are also stored, specifically in a list for all workpoints P0 . . . Px.

During the generation of the guide values for drives, not shown, from position inputs, these compensation values are included in the calculation in that the corresponding nominal position values are output, corrected by the associated compensation values, as guide values for controlling the drives. As a result, firstly, any position error existing at measuring points or selected workpoints P0 . . . Px disappears.

However, since, as a rule, the majority of possible workpoints in the workspace A is not included in these measurement values which only represent a representative selection of possible positions in the workspace A, any position errors which may exist in these areas located between the measuring points must also be compensated for.

According to the invention, therefore, the compensation values are interpolated in these intermediate spaces from the compensation table K as a result of which the deviations are also reduced there.

A possible procedure for carrying out the method according to the invention consists in storing a measuring log on the absolute positioning and, respectively, orientation accuracy, generated during the acceptance testing of a machine tool or of a robot, in a suitable form as compensation table K (compare FIG. 4) in the numeric control system. This table can then be used again for enhancing the accuracy in the manner described above. As a result, deviations can be drastically reduced. The expenditure for implementation and the requirement for computing time in a numeric control system for this purpose are relatively low.

A particularly effective implementation is obtained if a regular three-dimensional grid is placed over a cube-shape workspace A. Such a constellation is shown in the representation of FIG. 2 where the grid structure G is indicated. For each grid point, the workpoint P0 . . . Px to be measured, the deviation between the nominal position and the measured position must be entered in a data field. This deviation can also be called a “spatial deviation” rA at the relevant grid point which is illustrated in the representation of FIG. 3. The spatial deviation rA is nothing other than the vector between the nominal position X_soll and the actual position X_ist at the desired workpoint.

The values for the compensation table K can also be determined automatically. For this purpose, the processing machine can be moved to the desired positions in the workspace via a parts program. After each position has been reached, the actual position must be read out from, e.g. an external measuring means and transferred into the control system of the machine where the deviation rA can be determined and entered, together with the position, in the compensation table K.

The required storage space for the compensation table K can be optimized with a suitable choice of positions in the workspace. If, for example, the traversing area is equidistantly subdivided into distances Δx for each degree of freedom (e.g. the dimensions X, Y, Z in FIG. 1) of the machine, the measuring points P0 . . . Px are located on a regular grid. The representation of FIG. 1 is based on this relationship, where, by way of example, equidistant workpoints P0 to P16 are designated and each workpoint is distant from adjacent workpoints by Δx in all directions.

Each dimension X, Y and Z is described by specifying the minimum value 15 and maximum value and the number of equidistant intervals. This procedure offers the further advantage that the interpolation of the compensation values in the intermediate spaces can be implemented by very simple means and thus non-critically with respect to the runtime and to computing requirements.

1. A method for compensating for static position errors in guiding the movement of a moving machine element of an industrial processing machine such as a numerically controlled machine tool, a robot or the like, with a setpoint input for generating reference values for one or more drives for controlling the machine element in a predetermined workspace (A), comprising the following method steps:
inputting nominal positions (X_soll) for the machine element for a predetermined number of different workpoints (P0 . . . Px) in the workspace (A),
determining positioning errors (rA0 . . . rAx) by comparing a respective nominal position (X0_soll . . . Xx_soll) and actual position (X0_ist . . . Xx_ist) of the machine element for each of these workpoints (P0 . . . Px),
storing the respective nominal position (X0_soll . . . Xx_soll) and positioning error (rA0 . . . rAx) found in a compensation table (k),
taking into consideration the positioning errors (rA0 . . . rAx) of the compensation tables (K) as compensation values by
adding them in the generation of guide values for the drive or drives from the setpoint input in the respective nominal positions (X0_soll . . . Xx_soll) or by
interpolating the compensation values from the compensation table (K) in the intervals between the respective nominal positions (X0_soll . . . Xx_soll).

2. The method for compensating for static orientation errors in guiding the movement of a moving machine element of an industrial processing machine such as a numerically controlled machine tool, a robot or the like, with a setpoint input for generating reference values for one or more drives for controlling the machine element in a predetermined workspace (A), comprising the following method steps:
inputting nominal orientations (O_soll) for the machine element for a predetermined number of different workpoints (P0 . . . Px) in the workspace (A),
determining orientation errors (oA0 . . . oAx) by comparing a respective nominal orientation (O0_soll . . . Ox_soll) and actual orientation (O0_ist . . . Ox_ist) of the machine element for each of these workpoints (P0 . . . Px),
storing the respective nominal orientation (O0_soll . . . Ox_soll) and orientation error (oA0 . . . oAx) found in a compensation table (K),
taking into consideration the orientation errors (oA0 . . . oAx) of the compensation tables (K) as compensation values by
adding them in the generation of guide values for the drive or drives from the setpoint input in the respective nominal orientations (O0_soll . . . Ox_soll) or by
interpolating the compensation values from the compensation table (K) in the intervals between the respective nominal orientations (O0_soll . . . Ox_soll).

3. The method for compensating for static position and orientation errors as claimed in claim 1, in which the nominal positions are stored in the compensation table (K) with associated position errors which contain the respective nominal positions (X0_soll . . . Xx_soll) and nominal orientations (O0_soll . . . Ox_soll) and the position errors (rA0 . . . rAx) and orientation errors (oA0 . . . oAx).

4. The method for compensating for static position and/or orientation errors as claimed in claim 1, in which the workspace (A) of the processing machine has a cube-shaped form and is divided into a three-dimensional grid structure (G) for determining workpoints (P0 . . . Px), in which, for each grid point or a selection of grid points, the deviation between the nominal position (X0_soll . . . Xx_soll, O0_soll . . . Ox_soll) and the measured actual position (X0_ist . . . Xx_ist, O0_ist . . . Ox_ist) is stored in a data field of the compensation table (K).

5. The method for compensating for static position and/or orientation errors as claimed in claim 1, the compensation table (K) being embodied as data array.

6. The method for compensating for static position and/or orientation errors as claimed in claim 1, the traversing area of the machine element being equidistantly (Δx) subdivided for each degree of freedom of the processing machine.

7. The method for compensating for static position and/or orientation errors as claimed in claim 6, each dimension of the workspace (A) being described by the minimum value, the maximum value and the number of equidistant intervals (Δx).

8. The method for compensating for static position and/or orientation errors as claimed in claim 1, in which the method is carried out automatically when the processing machine is taken into operation, in that the desired positions in the workspace (A) are approached by a corresponding parts program with traversing instructions for the setpoint input and, after the respective position has been reached, the actual positions are measured and transferred into the control system of the machine where the deviations are determined in the form of position errors (rA0 . . . rAx) and/or orientation errors (oA0 . . . oAx) and, together with the associated positions, are entered in the compensation table (K).
